(19) United States
(12) Patent Application Publication
(10) Pub. No.: US 2006/0056480 A1
(43) Pub. Date: Mar. 16, 2006

(54) Actively stabilized systems for the generation of ultrashort optical pulses

(76) Inventors: Michael Marshall Mielke, Orlando, FL (US); Ismail Tolga Yilmaz, Orlando, FL (US); David Goldman, Orlando, FL (US); Mark Farley, Orlando, FL (US)

Correspondence Address: CARR & FERRELL LLP, 2200 GENG ROAD, PALO ALTO, CA, 94303, US

(21) Appl. No.: 11/229,302

(22) Filed: Sep. 15, 2005

Related U.S. Application Data
(60) Provisional application No. 60/609,866, filed on Sep. 15, 2004.

(51) Int. Cl. H01S 3/083

(52) U.S. Cl. 372/94

(57) ABSTRACT

A system and method for generating an optical laser pulse train of constant ultrashort pulse duration and low timing jitter in a fiber ring laser system (resonator) while keeping the laser resonator resilient to environmental conditions like temperature, humidity and pressure. The laser resonator may be actively mode-locked with a periodic electrically driven modulation at a specific frequency that corresponds to the inverse of the transit time inside the resonator. The optical pulse train quality may be monitored in real time, and the frequency of the modulation may be dynamically tuned in real time to compensate for resonator length changes due to changes in the environmental conditions.

### CROSS-REFERENCE TO RELATED APPLICATION

The present application claims the benefit and priority of U.S. provisional patent application Ser. No. 60/609,866, filed on Sep. 15, 2004, and entitled “Generating Optical Pulses for Producing High Power Spikes,” which is herein incorporated by reference.

### BACKGROUND OF THE INVENTION

1. Field of the Invention

The present invention relates to producing ultrashort optical pulses, and, in particular, to the use of an actively controlled seed for generating these pulses in an ultrashort-pulse laser system such as a chirped pulse amplification system.

2. Description of Related Art

a. Ultrashort-Pulse Laser Systems

Ultrafast laser technology has been known and used for over 20 years. Chemists and physicists developed ultrafast lasers for the purpose of measuring extremely fast physical processes such as molecular vibrations, chemical reactions, charge transfer processes, and molecular conformational changes. All these processes take place on the time scales of femtoseconds (fsec, 10⁻¹⁵ sec) to picoseconds (psec, 10⁻¹² sec). Carrier relaxation and thermalization, wavepacket evolution, electron-hole scattering, and countless other processes also occur on these incredibly fast time scales.

Optical science using ultrafast, ultrashort optical pulses has seen remarkable progress over the past decade. While definitions vary, in general “ultrashort” generally refers to optical pulses of a duration less than approximately 10 psec, and this definition is used herein. Numerous applications of ultrashort pulses have been developed that would be otherwise impossible or impractical to implement with other technologies. With ultrashort pulses, researchers have investigated many highly nonlinear processes in atomic, molecular, plasma, and solid-state physics, and accessed previously unexplored states of matter.

Many applications of ultrashort-pulse (USP) lasers make use of the very high peak power that each pulse momentarily provides. Although the average power from the laser may be quite moderate and the total energy within a pulse small, the extremely short duration of each pulse yields a peak, nearly instantaneous power that is very large. When these pulses are focused on a tiny spot, the high optical power is sufficient to ablate many materials, making a USP laser a useful tool for micromachining, drilling, and cutting. If needed, the precision of the material removal can even exceed that of the beam focus, by carefully setting the pulse intensity so that only the brightest part of the beam rises above the material ablation threshold. The material ablation threshold is the amount of energy density, or fluence, needed to ablate the material, often on the order of 1 J/cm². Optical pulses containing a much greater energy density are generally considered to be “high-energy” and this definition is used herein.

Ablation with a USP laser differs from longer duration pulse ablation techniques since most of the energy deposited on the surface by the ultrashort optical pulse is carried away with the ablated material from the machined surface, a process which occurs too rapidly for heat to diffuse into the surrounding non-irradiated material, thus ensuring smooth and precise material removal. For most materials, light pulses having a duration less than approximately 10 psec are capable of this non-thermal ablation when the pulse energy exceeds the ablation threshold of the material. Pulses with durations longer than about 10 psec can also ablate material if the pulse energy is greater than the ablation threshold, but thermal damage to the surrounding non-irradiated regions can occur.

Researchers have demonstrated non-thermal ablation techniques by accurately machining many materials, such as diamond, titanium carbide, and tooth enamel. In one interesting demonstration, USP lasers have been used to slice safely through high explosives; this is possible because the material at the focus is vaporized without raising the temperature of, and detonating, the surrounding material. Surgical applications also abound where ultrashort pulses are especially effective because collateral tissue damage is minimized. For example, researchers at Lawrence Livermore National laboratory have used ultrashort pulses to remove bony intrusions into the spinal column without damaging adjacent nerve tissue. Ophthalmic researchers have shown that USP lasers cut a smoother flap from a cornea than standard knife-based techniques and provide more control of the cut shape and location. There are numerous other applications as well. For the purposes of this invention, the term “ablation” used herein will refer to non-thermal ablation as discussed above and enabled by USP lasers, unless expressly indicated otherwise.

Nearly all high peak-power USP laser systems use the technique of chirped pulse amplification (CPA) to produce short-duration, high-intensity pulses. Optical CPA was proposed by Mourou and others in the 1980s, as an extrapolation from previous CPA techniques used in radar microwave applications. Chirped pulse amplification is used to increase the energy of a short pulse while keeping the peak power of the pulse below a level that can cause damage to the optical amplifier. In this technique, the duration of the pulse is increased by dispersing it temporally as a function of wavelength (a process called “chirping”), thus lowering the peak power of the pulse while maintaining the overall power contained in the pulse. The chirped pulse is then amplified, and then recompressed to significantly re-shorten its duration.

By lengthening the pulse in time, the overall pulse can be efficiently amplified by an optical amplifier gain medium while the peak power levels of the chirped pulse remain below the damage threshold of the optical amplifier. The more a signal can be stretched, the lower the peak power, allowing for the use of either lower peak power amplifiers or more efficient amplifiers, such as semiconductor optical amplifiers (SOAs). The CPA technique is particularly useful for efficient utilization of solid-state optical gain media with high stored energy densities, where full amplification of a non-chirped short duration pulse is not possible since the peak power of the pulse is above the damage thresholds of the amplifier materials. Techniques for generating ultra-short pulses are described in, e.g., Rulliere, C. (ed.), Femtosecond Laser Pulses, (Springer-Verlag, New York, 1988).

A typical CPA system is illustrated in FIG. 1 and works as follows. Ultrashort light pulses are generated at low pulse energies (typically less than 1 nJ) through the use of a modelocked laser oscillator, or “seed source” 101. These pulses are chirped with a chromatically dispersive system or a “stretcher” 102, which may be as simple as a standard silica optical fiber or a diffraction-grating arrangement. The dispersive system stretches the pulse temporally, increasing its duration by several orders of magnitude from, e.g., a duration under 1 psec to approximately 1 nanoseconds (nsec, 10⁻⁹ sec), or three orders of magnitude (1000 times). This decreases the pulse peak power by the same factor, three orders of magnitude in this example, so that the total energy contained in the pulse remains approximately constant. Next, the stretched pulse is amplified by one or more stages of optical amplification 103 to increase the energy of the pulse. After amplification, the stretched pulse is compressed by a pulse compressor 104 to a pulse having a duration near the original input pulse duration. Finally, the ultrashort, high energy pulse is delivered to a desired location by some delivery mechanism 105. Graphical representations of the treatment of a single pulse are shown between the elements in FIG. 1 (not to scale).

b. Mode-Locked Seed Lasers

Ultrashort pulses were first observed in the 1970's, when it was discovered that they could be produced by mode-locking a broad-spectrum laser. In mode-locking, a fixed phase relationship between the modes of the laser's resonant cavity is established. It is the interference between these modes that creates a train of optical pulses that can be used in the ultrashort-pulse laser systems described above, as well as other applications.

The minimum pulse duration attainable is limited by the bandwidth of the gain medium, which is inversely proportional to this minimal or Fourier-transform-limited pulse duration. Mode-locked pulses are typically very short and will spread due to dispersion as they traverse any medium. Subsequent pulse-compression techniques are often used to obtain USP's. A traditional diffraction grating compressor is shown, e.g., in U.S. Pat. No. 5,822,097 by Tournois. Pulse dispersion can occur within the laser cavity so that compression (dispersion-compensating) techniques are sometimes added intra-cavity.

### SUMMARY OF THE INVENTION

The present invention includes a system and method for generating an optical pulse train of constant ultrashort pulse duration and low timing jitter that is resilient to environmental conditions like temperature, humidity, pressure, radiation exposure, vibration, and aging.

In the present invention, the optical pulse train is generated in a fiber ring laser system that may be actively mode-locked with a periodic electrically driven modulation at a specific frequency that corresponds to the inverse of the transit time inside the fiber ring laser system. The frequency may be dynamically tuned in real time to compensate for length changes in the ring due to changes in the environmental conditions.

The tuning may be accomplished by sensing in real time the optical pulse train generated by the fiber ring laser system using either an optical power monitor to measure average power, and/or a two-photon absorption detector to measure peak power. Pulse duration can be calculated by using these two measurements together.

In some embodiments, the optical pulse train is generated by amplified spontaneous emission (ASE) from an optical amplifier and an electro-optical modulator (EOM) in the ring. The repetition rate of pulses in the fiber ring laser system is controlled by driving the EOM from its lower opaque region, up through its transparent region and into its upper opaque region to gate out a pulse and then reversing the process such that the EOM goes down through its transparent region to generate another pulse (and repeatedly up and down to generate a series of pulses). In general, the electrical pulses are about equal in duration to the time between optical pulses, such that the optical pulses are about evenly spaced.

In harmonic mode-locking, one optical pulse may pass through the EOM during the period of transparency caused by the rising edge of the electrical pulse, and a second optical pulse may pass through the EOM during the period of transparency caused by the falling edge of the electrical pulse. To synchronize the EOM to the spacing of the optical pulses, the relationship between the duration of the pulses to the time between pulses may be adjusted as necessary.

A digitally-controlled signal generator may be used in a feedback loop to electrically drive the EOM and thereby actively stabilize the generation of ultrashort optical pulses in the fiber ring laser system. Being digitally controllable allows both a wide range and the use of commercially available subsystems. The system can be controlled from a laptop or other computer (e.g., microcontroller). A digital control can be used to vary the time between optical pulses. In some embodiments, the rise and fall times of the electrical pulses can also be digitally varied and thus the duration of the optical pulses also controlled.

The tuning of the frequency of the EOM, and thus the mode-locking of the fiber ring laser system, may be accomplished by simply changing the frequency of the electrical pulse generator driving the EOM.

### BRIEF DESCRIPTION OF THE DRAWINGS

FIG. 1 is a block diagram of a typical chirped pulse amplification system in the prior art.

FIG. 2 is a simplified diagram of a mode-locked fiber ring laser system that may be used in a chirped pulse amplification system.

FIG. 3 is a more detailed diagram of a mode-locked fiber ring laser system that may be used in a chirped pulse amplification system.

FIG. 4 is a simplified diagram of a mode-locked fiber ring laser system according to one embodiment of the present invention.

FIG. 5a shows the spectrum analysis of an output pulse train with a pulse repetition rate of 20 MHz when the laser cavity is in resonance according to one embodiment of the present invention.

FIG. 5b shows the spectrum analysis of an output pulse train with a pulse repetition rate of 20 MHz when the laser cavity is drifting out of resonance according to one embodiment of the present invention.

FIG. 6 is a flowchart showing a basic process for controlling the mode-locked fiber ring laser system of FIG. 4 according to one embodiment of the present invention.

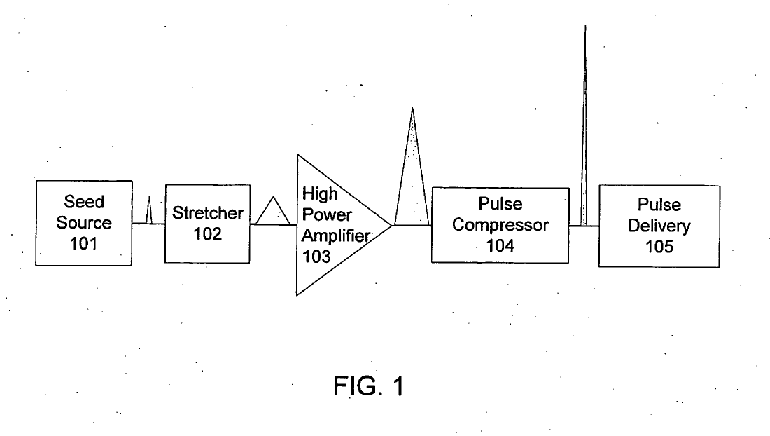

### DESCRIPTION OF PREFERRED EMBODIMENTS

The present invention provides actively stabilized systems and methods for production of ultrashort optical pulses. Prior USP systems have generated and shaped a very short pulse, stretched the pulse to, e.g., 100 ps, amplified it, and compressed it back to approximately its original sub-picosecond duration. The relatively simple method herein does not require pulse-shaping or extremely short generated electrical pulses. Instead, the present invention provides a fiber ring (also referred to herein as a cavity) laser system that may include a source of optical pulses (e.g., an optical amplifier) and an EOM (electro-optical modulator) electrically driven from its lower opaque region, up through its transparent region and into its upper opaque region to gate out a pulse and then reverses the process such that the EOM goes down through its transparent region to generate another pulse (and repeatedly up and down to generate a series of pulses). The electrical pulses may be about equal in duration to the time between optical pulses, such that the optical pulses are about evenly spaced.

The present invention further may use a digitally-controlled electrical signal generator to electrically drive the EOM from its lower opaque region, up through its transparent region and into its upper opaque region, and then back down again. Being digitally controllable allows both easy control of the time between optical pulses and the duration of the optical pulses, as well as the use of commercially available subsystems. For example, the system can be controlled from a laptop or other computer such as a microcontroller. Thus, the optical pulse generation can be relatively simple and inexpensive, e.g., using just an optical amplifier, a digitally-controlled electrical EOM-driver circuit, and an EOM. These are generally built into a single unit specifically made for mode-locking; however, other embodiments containing these elements may also be used. Optical pulses from the fiber ring laser system may be generated at controlled repetition rates from a few Hz up to 500 MHz. In application within a complete laser system, the optical pulses from the fiber ring laser system may be stretched, amplified, and then compressed in a traditional CPA system.

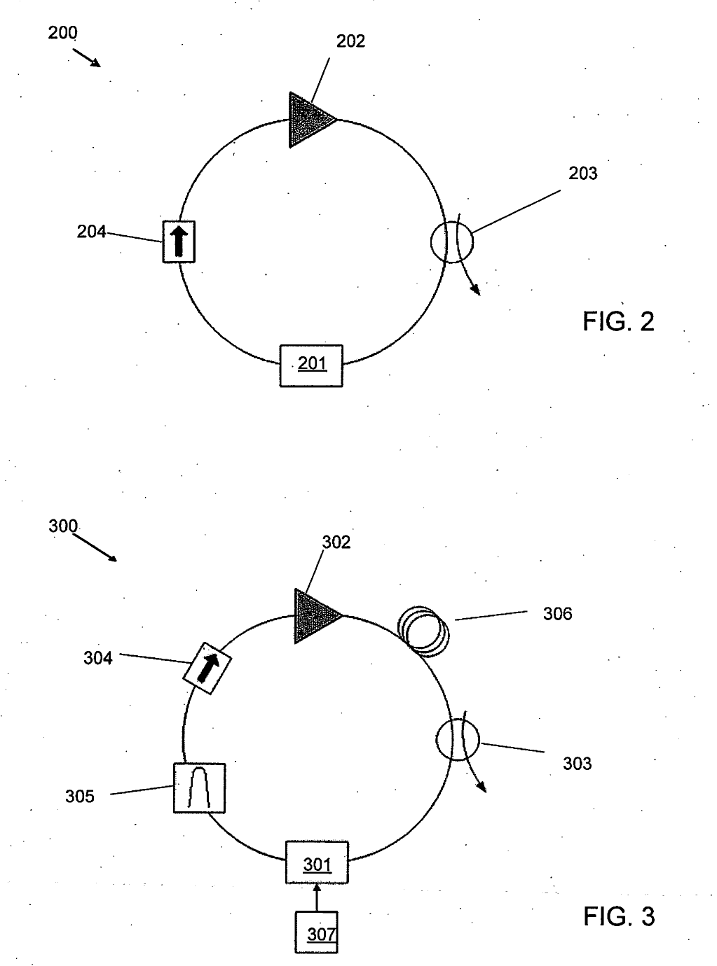

FIG. 2 shows a simplified block diagram of a mode-locked fiber ring laser system 200 that may be used to generate ultrashort pulses, in one embodiment in accordance with the present invention. The fiber ring laser system 200 includes an optical modulator 201 coupled via an optical isolator 204 to an optical amplifier 202 and to an optical tap (e.g., fixed ratio splitter) 203. The term “fiber ring” means that each of the components of the fiber ring laser system 200 are interconnected by fiber pigtails. The fiber ring laser system 200 therefore includes a continuous optical path through optical fiber.

In basic principle of operation, the fiber ring laser system 200 generates light initially by amplified spontaneous emission (ASE) of noise or random photons in the optical amplifier 202. During the start-up dynamics of the fiber ring laser system 200, the optical amplifier 202 generates spontaneous optical noise. The spontaneous photons can be considered pulses of light, or more appropriately, macroscopic bursts of light. In this sense, the optical amplifier 202 generates continuous noise until the optical modulator 201 “carves a pulse” out of the continuous stream of noise, and this transmitted bit of noise circulates back to the optical amplifier 202 during the start-up evolution. After several cycles through the optical amplifier 202 and optical modulator 201, the bit of noise evolves into a steady state pulse in the ring. In steady state, amplification of the circulating pulses tends to deplete all of the energy from the optical amplifier 202, and spontaneous emission is suppressed. The optical tap 203 comprises a “cavity output coupler” that couples a portion of the pulses from the optical amplifier 202 to the modulator 201 and also allows pulses to be taken out of the fiber ring laser system 200 so that they may be further processed, for example in a CPA system. The light photons or pulses from the optical amplifier 202 within the fiber ring laser system 200 may be passively or actively modulated by the modulator 201, as described further below. The optical isolator 204 keeps light propagating unidirectionally in the fiber ring laser system 200, preventing any backward travel of the optical pulses. In essence, the fiber ring laser system 200 operates by self-oscillation, with characteristics further described below.

Note that some of the components of the fiber ring laser system 200 may be interchanged or reordered within the ring. For example, the isolator 204 could be positioned after the optical amplifier 202, and/or the optical tap 203 could be placed before the optical amplifier 202.

FIG. 3 shows a more detailed diagram of a mode-locked fiber ring laser system 300, in one embodiment in accordance with the present invention. The fiber ring laser system 300 includes an optical modulator 301 coupled to an optical spectral bandpass filter 305. The bandpass filter 305 confines the emission from the optical modulator 301 to a desired band of wavelengths (e.g., a band 5-10 nm wide), to remove unwanted wavelengths of light and reduce noise in the fiber ring laser system 300. An optical isolator 304 couples the filtered output from the bandpass filter 305 to an optical amplifier 302, such as an erbium doped fiber amplifier (EDFA) that spontaneously generates, receives, and amplifies pulses in the fiber ring laser system 300.

A coil of optical fiber 306 provides for a delay in the propagation of the pulses in the fiber ring laser system 300 and is used to adjust the length of the ring to a specific frequency. The net length of the fiber ring laser system 300 determines the rate (e.g., from tens of MHz to several GHz) at which the fiber ring laser system 300 puts out pulses. For example, for a fundamental frequency of about 10 MHz in one embodiment, the cavity length is about 20 meters. The pigtails and the components of the fiber ring laser system 300 are not long enough to yield 20 meters total length, so the coil of optical fiber 306 is included to extend the cavity length in the fiber ring laser system 300 to about 20 meters. Typically the coil of optical fiber 306 is the same fiber (e.g., singlemode fiber) as that used in the pigtails of the other components of the fiber ring laser system 300.

Optical tap 303 allows for propagation of pulses within the ring and extraction of pulses from the fiber ring laser system 300. Optionally, a polarization controller, polarizer, and optical filter (not shown) may be provided within the fiber ring laser system 300.

A controller 307 controls the mode-locking function of the optical modulator 301, as described further herein. There are various techniques by which controller 307 may accomplish mode-locking of the modulator 301 in the configuration shown in FIG. 3. These techniques may be either active, in which an external signal induces a modulation of the light in the modulator 301, or passive, in which elements in the modulator 301 cause self-modulation of the light, or some combination of both, although most of the commercially available mode-locked lasers operating below 100 MHz are passive. Without the system and method of the instant invention, active mode-locking generally only works in narrow ranges and requires manual adjustments to obtain satisfactory results, while passive mode-locking can only compensate for limited variations.

Passive techniques include such things as a saturable absorber, a device that exhibits an intensity-dependent transmission, generally absorbing low-intensity light and transmitting light of sufficiently high intensity. This allows the high-intensity spikes of light to be selectively amplified, leading to a train of pulses and self-mode-locking of the laser.

Other passive techniques rely on other non-linear effects rather than intensity dependent absorption, for example the Kerr effect, which results in high-intensity light being focused differently than low-intensity light. Employed carefully, this can result in the equivalent of an ultra-fast response saturable absorber.

Still other passive techniques rely upon dispersion management in the laser cavity, or upon changing the cavity length to adjust for stress or strain, or temperature, which changes the length of the cavity. Other techniques used include a heated fiber ring to prevent temperature variations and the resulting change in the resonant frequency of the loop or changes in the refractive index of the fiber.

In some embodiments, modulator 301 comprises an electro-optic modulator (EOM). An EOM operates somewhat like the shutter in a camera by transitioning from opaqueness to transparency over a voltage transition known as the half-wave voltage, producing an amplitude modulation of the light. However, EOMs in the prior art typically either operate at a fixed frequency or must be manually tuned. Yet another active technique is synchronous mode-locking, or synchronous pumping, in which the pump source which provides energy for the laser is itself modulated, effectively turning the laser on and off to produce pulses.

Some sophisticated specialty electronic devices for actively mode-locking a laser cavity are presently available. One of these is a radio frequency comb generator circuit which may be used to boost the electrical signal just before it is inserted into the EOM, thus conditioning the electrical drive to the EOM. Not only is this circuit costly, it also has a very limited range of supported pulse repetition rates.

A comb generator receives a sine wave at a certain frequency and outputs the original frequency plus numerous upper harmonics of that frequency, each having significant power. The harmonic content resembles a frequency comb in the spectral domain, and in the time domain the sum of the harmonics results in a very short electrical impulse, or spike. Thus, the output of the comb generator is a train of spikes of the same frequency as the sine wave. Each spike has a magnitude of approximately V_{τ}, where V_{τ} is the half-wave voltage of the EOM, i.e., the voltage that turns the EOM from opaque (minimum transparency) to transparent (maximum transparency).

The comb generator approach has several limitations of its own. The pulses used to control the 401 must be short, and since the width of the resulting pulse is related to the length of each period of the input sine wave, comb generators work best with high frequency signals, e.g., 100 MHz or more. In addition, the circuits used to convert a sine wave into a pulse train may be complex. Often a generated pulse will have a tail of after-pulses, which may be of great enough magnitude to affect the transparency of the EOM. Further, comb generators only operate in narrow bands. For example, a 100 MHz comb generator may only work on sine waves of 100 MHz±approximately 1%. Thus, the frequency input into the EOM cannot be tuned to compensate for other factors.

Mode-locking may be either fundamental, in which a single pulse travels around the ring, or harmonic, in which multiple pulses travel around the ring at the same time with a constant spacing. One significant problem with mode-locking a long laser cavity, as is the case with a fiber laser cavity, is the possibility of instability, i.e., variations in the pulse spacing. There are a number of factors that can cause such instability. Changes in the environment such as temperature, humidity, pressure, radiation exposure, vibration, aging, etc., all may cause changes in the effective length of the resonant cavity, and thus in the phase relationship between the modes in the cavity and the pulse spacing.

For example, the effective cavity length L changes with temperature as follows:

$$\frac{ⅆ L}{ⅆ T} = l \frac{ⅆ n}{ⅆ T} + n \frac{ⅆ l}{ⅆ T} .$$

The effective cavity length is L=n·l, where l is the fiber length, n is the fiber refractive index and T stands for temperature. For silica glass fiber, dn/dT≈10⁻⁵/° C. while l·dl/dT≈5·10⁻⁷/° C. As a result, the refractive index change with temperature dominates the temperature dependent length change in the fiber, and ΔL=l·Δn.

Pulse repetition rate is related to the cavity length by

$${f}_{rep} = \frac{c}{n \cdot l} ,$$

where c is the speed of light. The changes in cavity pulse repetition rate and pulse period with temperature are then

$$Δ {f}_{rep} = Δ n \cdot \frac{c}{{n}^{2} \cdot l} and Δ τ = \frac{l \cdot Δ n}{c} ,$$

respectively. Here, τ is the pulse period and the temperature dependence is through the refractive index. For example, for an external cavity laser with 10 MHz repetition rate, assuming n=1.5 and a temperature change of 1° C., Δfᵣₑₚ=66.7 Hz and Δτ=0.7 ps.

When such instabilities occur, it is necessary to tune the ring to compensate for the change in the effective length of the laser cavity and return the ring to a proper harmonic mode-locked state. While some of the methods discussed above will limit the instability due to some of these factors (e.g., a heated fiber ring will limit changes in the index of the fiber due to temperature variations), none of them will cover all such changes, or allow for substantial tuning to compensate for large changes.

There are no known commercial systems for monitoring the output pulses and adjusting the mode-locking by means of feedback to compensate for these instabilities. Therefore, the fiber ring laser system of the present invention includes a system and method of mode-locking that allows the use of standard IC circuit chips, is actively stabilized, and allows for the generation of ultrashort pulses at arbitrary repetition rates.

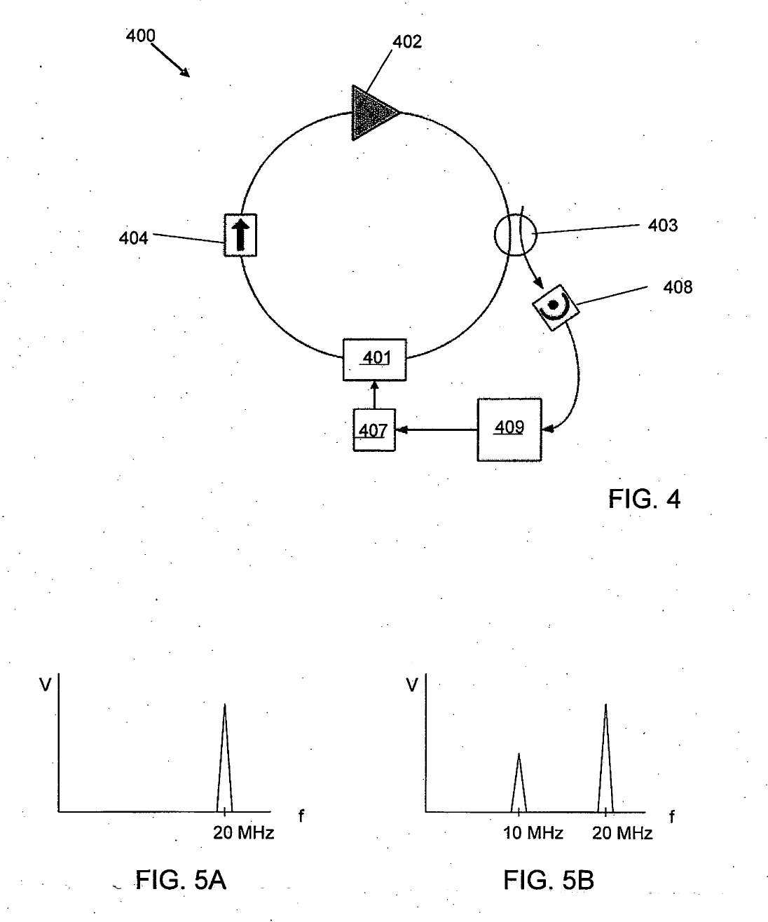

FIG. 4 shows a simplified diagram of one embodiment of a mode-locked fiber ring laser system 400 according to the present invention. An optical modulator 401 comprises an EOM. An optical amplifier 402 comprises, for example, an EDFA or semiconductor optical amplifier. An optical tap 403 circulates pulses around the ring and allows pulses to be removed from the ring. An optical isolator 404 ensures that pulses travel unidirectionally around the ring.

The principle of operation of the fiber ring laser system 400 is similar to that described above with respect to FIG. 2. Not shown is an optical tap that removes pulses from the ring for further processing, for example to utilize the fiber ring laser system 400 as a seed in a CPA system. Also not shown is an optional bandpass filter that may be included in the fiber ring laser system 400 as in FIG. 3 to force oscillation at a particular wavelength.

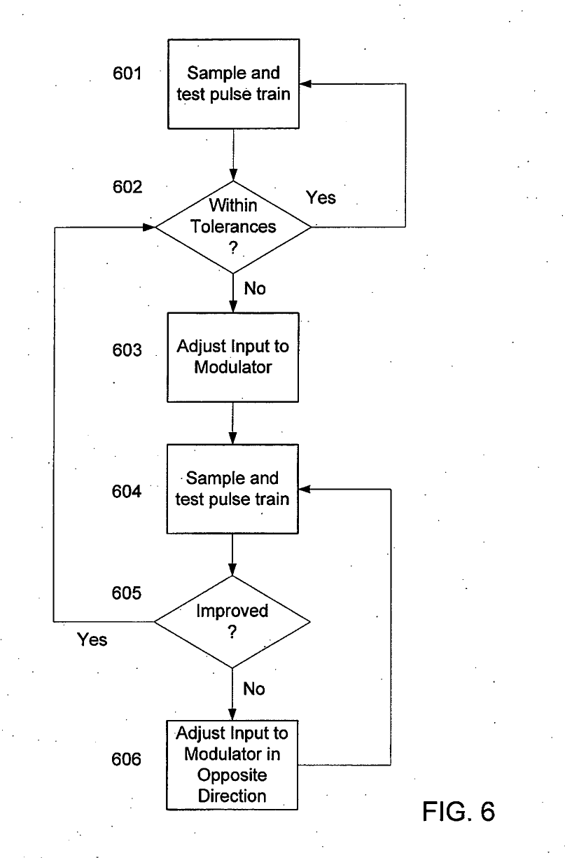

As described further with respect to FIG. 6 below, in a feedback loop around the ring, one or more detectors 408 detect the output pulse train and feed the results to a processor 409 for analysis. The processor 409 may comprise any combination of hardware, software, and/or firmware for varying the input to the modulator 401 as described further herein. In some embodiments, the processor 409 comprises software running on a laptop computer, but the processor 409 may comprise a hardware logic circuit or a microcontroller, for example. Based on the detected output pulse train from the detectors 408, the processor 409 sends a signal to a signal generator 407 to generate an electrical signal (e.g., square wave or pulse train) to control the EOM 401. For example, in some embodiments the signal generator 407 generates a square wave signal to the modulator 401 and may change the frequency of the square wave signal if necessary to correct for changes in the optical pulse repetition rate due to changes in the environment.

Due to the active feedback and real-time monitoring of the output optical pulses, it is not necessary to preprogram any particular correction mechanism into the processor 409 in some embodiments. Rather, the processor 409 may be programmed to recognize the acceptable limits on variations of the output and to respond when the output exceeds those limits by commanding the signal generator 407 to adjust the frequency of the square wave, the DC bias to the EOM, and perhaps other inputs to the fiber ring laser system 400.

In one embodiment, the processor 409 simply tells the signal generator 407 to, for example, increase the frequency of the square wave for a few milliseconds. The output pulse train is continually sampled and changes will be detected almost instantly. If the output pulse train improves, it indicates that the frequency is being changed in the right direction, and the frequency is increased until a proper output is obtained. If, on the other hand, the output pulse train continues to degrade when the square wave frequency is increased, then the processor 409 will see the change and will instruct the signal generator 407 to decrease the frequency of the square wave until the pulse train is corrected. Of course, the processor 409 could also follow this procedure in reverse, i.e., first instruct the signal generator 407 to decrease the frequency of the square wave and test the result. (As below, in some embodiments there is an indication of the direction in which the frequency should be changed.) Other parameters of the electrical signal to the EOM 401 may be similarly changed for brief periods and the output sampled for either improvement or further degradation.

There are other algorithms that may be used to maintain optimized tuning of the fiber ring laser system 400. For example, microwave or RF frequency analysis described further herein may indicate the direction of detuning of the output signal and thus the direction in which the frequency of the control signal driving the EOM 401 should be adjusted to correct for the detuning.

The most prominent change in the output pulse train is generally due to temperature variations, since this can change the length of the cavity and thus the resonant frequency of the fiber ring laser system 400. In one embodiment, a temperature sensor (e.g., thermistor) may be attached to monitor the temperature of the modulator 401, and that data fed to the processor 409, so that the temperature of the modulator 401 may be used in conjunction with the analysis of the output pulse train to determine what changes to make in the frequency of the signal generator 407. Drift of the output due to such temperature variations may cause a sharp drop in the maximum output of the fiber ring laser system 400 which is detectable by the detector 408.

Further, the detector 408 can indicate which way the processor 409 should adjust the frequency of the square wave to compensate for these variations. An increase in temperature makes the ring longer; to compensate for this, the frequency may be reduced in small steps until resonance is reestablished (or as close to resonance as is needed to get an acceptable output).

In one embodiment, the signal generator 407 generates a square wave signal of magnitude of 2 times the half-wave voltage V_{τ}. The 2 V_{τ} value is chosen so that at the leading edge of the square wave, the EOM 401 is driven from a lower opaque region, when the square wave signal has a magnitude less than V_{τ}, through the transparent region around V_{τ}, and back to opacity as the square wave signal becomes greater than V_{τ}. At the trailing edge of the square wave, the situation is reversed, but the result is the same. The EOM 401 begins in its upper opaque region when the square wave signal is greater than V_{τ}, then passes through the transparent region around V_{τ}, and becomes opaque again as the square wave signal value approaches zero.

The duration of the transparency window of the EOM 401 is defined by the rise or fall time (“edge rate”) of the leading or trailing edge, respectively, of the square wave or other waveform used. In some embodiments, the square wave has an edge rate of less than approximately 400 ps. In alternative embodiments, the electrical signal driving the EOM 401 comprises a pulse train having a substantially trapezoidal shape and an edge rate of less than approximately 400 ps. It is possible to create an edge rate of less than 10 ps using inexpensive electronic chips. With such signals driving the modulator 401, the transition through V_{τ} of the modulator 401 may have a jitter of less than approximately 20 ps.

In some embodiments, the EOM 401 is electrically driven by a square wave at an essentially fixed frequency, and a pulse picker (not shown) is used to select a fraction of the oscillator pulses in the fiber ring laser system 400 and the selected fraction is varied to at least principally control the output pulse energy. The pulse picker and a pulse-energy-controlling SOA may both use the same SOA. Pump diodes of the amplifier 402 may alternately used to control output pulse energy.

Varying the frequency of the EOM 401 is, however, preferred. This may be accomplished by varying the rate of the square wave from the signal generator 407, even at very low pulse rates. For example, pulses can be output using this active mode-locking at rates such as 10 MHz, rather than the 100 MHz and higher seen in active mode-locking systems in the prior art.

The frequency of the square wave from the signal generator 407 may be altered to tune the mode-locking to any desired frequency in order to compensate for changes in the resonance of the fiber ring laser system 400. Any changes in temperature, humidity, pressure, radiation exposure, vibration, aging, etc., may cause changes in the effective length of the resonant cavity, and thus in the phase relationship between the modes in the cavity. These changes may be compensated for by altering the frequency of the mode-locking so that the phase relationship is reestablished and the proper pulse train is generated.

While a true square wave may be used to drive the EOM as described with respect to FIG. 4, another embodiment includes varying the relationship between the duration of each electrical pulse and the time between pulses generated by the signal generator 407. In harmonic mode-locking, one optical pulse may pass through the EOM 401 during the period of transparency caused by the rising edge of the electrical pulse, and a second optical pulse pass through the EOM 401 during the period of transparency caused by the falling edge of the electrical pulse. To synchronize the EOM 401 to the spacing of the optical pulses, the relationship between the duration of the pulses to the time between pulses may be adjusted as necessary.

In order to determine how to vary the electrical signal, the output optical signal is monitored so that the appropriate tuning may be done. This is possible, although it is not a trivial task. Several types of detectors 408 may be used for this purpose.

The first of these is a two-photon absorption detector. This is a semiconductor that detects light in a preferred wavelength range, for example, visible light to 1000 nm. A detector of this range is not normally sensitive to continuous wave light outside its range, such as 1550 nm, due to the bandgap of silicon unless two photons hit at once. This is unlikely in continuous wave light because the photons are random. (While silicon is commonly used for such detectors, other semiconductors may be used as well.) However, in an ultrashort pulse, all of the photons are contained in a window of approximately 1 ps or so. This makes it likely that 2 or more photons will hit the detector and generate a current which indicates the peak power of the output pulses.

Another detector that may be used for sensing the optical pulse train quality in real time is an optical power monitor, typically an InGaAs semiconductor device, which measures average power by producing an electrical current proportional to the strength of the optical signal which is incident upon it. Pulse duration can be calculated by using the average power measurement together with the peak power signal from the two-photon absorption detector. These signals may be analyzed to determine the quality of the output pulse train, and from this a signal may be fed back to the signal generator 407 to control the output pulse train.

Another technique for measuring pulse duration is microwave or RF frequency analysis. This frequency analysis may be accomplished by feeding the tapped output of the fiber ring laser system 400 to a spectrum analyzer or other frequency-discriminating circuit. A 10 MHz square wave should produce a 20 MHz pulse repetition rate since there are both rising and falling edges which turn the EOM 401 transparent. Thus, when properly tuned, the spectrum analyzer should show a relatively clean spike at 20 MHz, as shown in FIG. 5A. When the fiber ring laser system 400 drifts out of resonance, the spectrum analyzer will show either an additional small spike at 10 MHz as shown in FIG. 5B, or a broadened spike at 20 MHz, or both. Frequency analysis may be an alternative to, or complementary to, the combination of the two-photon detector and optical power monitor discussed above.

In one embodiment, it is determined whether the signals from the two-photon absorption detector and the power monitor reach certain values. For example, the two-photon absorption detector may be monitored so that its maximum output is obtained at the minimum pulse width, i.e. resonance of the fiber ring laser system 400. If the output of the two-photon absorption detector does not reach the designated value, this indicates that the resonant cavity is out of tune and that the frequency of the signal generator 407 must be changed to compensate for variations in the resonance of the fiber ring laser system 400. Other adjustments may also need to be made to the EOM 401. For example, the DC bias to the EOM 401 or the peak-to-peak amplitude of the square wave may need to be adjusted. (Problems with the DC bias will typically show up on the power monitor.) Either of these types of monitoring may be easily done by a computer or other processor 409. An appropriate signal may then be sent to the signal generator 407 to adjust the mode-locking and thus reestablish the desired phase relationship of the modes in the resonant cavity.

A flowchart showing a basic process for controlling the mode-locked fiber ring laser system 400 of FIG. 4 is shown in FIG. 6 according to one embodiment of the present invention. The pulse train generated by the fiber ring laser system 400 is sampled and tested as described herein at step 601. In step 602, it is determined whether the pulse train falls within the acceptable limits of the output. If the pulse train falls within those limits, no action is taken, and the process returns to step 601 to test the pulse train again at some predetermined interval. If the pulse train does not fall within the acceptable output limits, the input to the EOM 401 is adjusted at step 603 by, for example, changing the frequency of the square wave input as described herein.

The pulse train is then sampled again at step 604 after some interval, and it is then determined at step 605 whether the quality of the pulse train has improved, i.e. whether it has moved closer to the acceptable output limits, or not. If the pulse train quality has improved, the process returns to step 602 to see whether it is within the acceptable output limits. If the pulse train is now within the acceptable output limits, no further change is made and the process again returns to step 601 for normal monitoring; if not, steps 603 to 605 are repeated and further changes made to the EOM 401 input until the pulse train is back within the acceptable output limits.

On the other hand, if it is determined at step 605 that the quality of the pulse train has not improved, i.e. has deteriorated further, then the input to the EOM 401 is adjusted in step 606, but now in the opposite direction to the change made in step 603. The process then returns to steps 604 and 605 to test the pulse train after the change to see whether there is improvement or not, and proceeds again as described above. Thus, the feedback causes changes to the input to the EOM 401, for example by varying the frequency of the square wave, to be made in one direction as long as the output improves until it is again within the acceptable output limits; where the output deteriorates further, indicating that the input is being moved in the wrong direction, the feedback results in changes in the other direction.

The DC bias voltage to the EOM 401 is also subject to drift, although this is a smaller effect. This can be corrected by sampling the output of the EOM 401 and setting the bias to get the minimum power output there, so that the EOM 401 is opaque at that level and then passes through the window of transparency and back down again as the square wave is applied.

In an alternative embodiment, DC bias drift may be monitored by sampling the pulse train emitted by the EOM 401 and testing the sample with a photodetector having a bandwidth greater than or equal to the repetition rate of the pulse train. The resulting signal is passed through a filter covering the frequency from DC to the frequency of the pulse train from the EOM 401, and then fed into the DC bias port of the EOM 401. This feedback loop will maximize the power in the signal that passes through the filter, and cause all tones in the electrical spectrum to have the same power.

Another alternative is to have the filter centered at the frequency of the pulse train fed into the EOM 401, with a bandwith narrow enough to pass the tone corresponding to that repetition rate. Again feeding the resulting signal into the bias port of the EOM 401 will maximize the power of the signal passing through the filter.

The present invention is well suited to pulse generation in CPA systems, where the pulses generated as described herein would be stretched, amplified and then compressed to create high-power ultrashort pulses. However, the present invention is not limited to use in CPA systems, but rather may be used in any situation in which an environmentally stable laser seed is desired.

Although the present invention and its advantages have been described above, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

What is claimed is:

1. A stable seed laser ring system for producing a plurality of ultrashort optical pulses, comprising:
a ring including a source for generating optical pulses, a modulator having an input for controlling the length of the optical pulses generated by the source, and an optical pulse sampler for sampling the optical pulses; and
a feedback loop coupled to the optical pulse sampler, the feedback loop including an optical detector for detecting changes in the optical pulses due to changes in the environment and a controller for varying the input to the modulator in response to the environmental changes such that the optical pulses remain significantly unaffected by such changes.

2. The system of claim 1 wherein the controller for varying the input to the modulator further comprises:
an electrical pulse generator; and
a frequency controller for varying the frequency of the pulses generated by the electrical pulse generator.

3. The system of claim 2 wherein the electrical pulse generator produces a square wave having a magnitude sufficient to transition the modulator from opaque to transparent to opaque.

4. The system of claim 2 wherein the electrical pulse generator produces a square wave having a magnitude of about 2 times the V_{τ} of the modulator.

5. The system of claim 3 wherein the frequency controller for varying the frequency of the pulses generated by the electrical pulse generator further comprises circuitry for varying the frequency of the square wave.

6. The system of claim 2 wherein the frequency controller for varying the frequency generated by the electrical pulse generator further comprises circuitry for varying the time between pulses.

7. The system of claim 1 wherein the optical pulse sampler for sampling the optical pulses further comprises an optical tap for removing the pulses from the ring.

8. The system of claim 1 wherein the optical detector comprises a two-photon absorption detector.

9. The system of claim 1 wherein the optical detector comprises an optical power monitor.

10. The system of claim 1 wherein the optical detector comprises a spectrum analyzer.

11. The system of claim 1 wherein the modulator comprises an electro-optic modulator.

12. A method of producing a plurality of ultrashort optical pulses in a laser ring system, comprising:
generating a plurality of optical pulses by self-oscillation of an optical amplifier coupled in a ring to an electrically driven electro-optic modulator, in which the length of the pulses is determined by the period during which the modulator is in a transparent state;
sampling the optical pulses in the ring;
detecting changes in the optical pulses due to changes in the environment; and
adjusting the electrical signal to the modulator in response to the sampled pulses to compensate for any environmental changes such that the optical pulses in the ring remain significantly unaffected by such changes.

13. The method of claim 12 further comprising driving the modulator with a square wave, and wherein adjusting the electrical signal to the modulator further comprises changing the frequency of the square wave.

14. The method of claim 13 in which the magnitude of the square wave is about 2 times the V_{τ} of the modulator.

15. The method of claim 13 in which adjusting the electrical signal to the modulator further comprises adjusting the frequency of the square wave to a frequency at which the ring is in resonance.

16. A method of producing a plurality of ultrashort optical pulses in a laser ring system, comprising:
generating laser light with a source;
inputting the generated laser light to an electrically driven electro-optic modulator to result in modulated light;
returning the modulated light to the source to establish the ring;
supplying a varying electrical signal to the modulator such that the modulator alternates between a transparent state and an opaque state and outputs optical pulses during the transparent state;
sampling the output optical pulses;
detecting changes in the optical pulses due to changes in the environment; and
adjusting the frequency of the electrical signal to the modulator in response to the sampled optical pulses to compensate for any environmental changes such that the optical pulses remain significantly unaffected by such changes.

17. The method of claim 16 wherein supplying a varying electrical signal to the modulator comprises supplying a square wave to the modulator.

18. The method of claim 17 wherein the square wave has a magnitude greater than V_{τ} which is sufficient to transition the modulator from opaque to transparent to opaque.

19. The method of claim 17 wherein the square wave has a magnitude of about 2 times the V_{τ} of the modulator.

20. The method of claim 16 wherein adjusting the frequency of the electrical signal to the modulator comprises adjusting the frequency of the electrical signal to a frequency at which the ring is in resonance.

21. The method of claim 17 wherein the square wave has a rise time of less than approximately 400 ps.

22. The method of claim 18 wherein the transition through V_{τ} of the modulator has a jitter of less than approximately 20 ps.

23. The method of claim 16 wherein supplying a varying electrical signal to the modulator further comprises supplying a pulse having a substantially trapezoidal shape and a rise time of less than approximately 400 ps to the modulator.
